(19) United States
(12) Patent Application Publication
(10) Pub. No.: US 2009/0212549 A1
(43) Pub. Date: Aug. 27, 2009

(54) Passenger safety restraint, seat height adjustment assembly and method of restraining a passenger

(76) Inventor: Bryan Edward Jones, Kimberley (ZA)

Correspondence Address: LADAS & PARRY LLP, 26 WEST 61ST STREET, NEW YORK, NY, 10023, US

(21) Appl. No.: 11/920,201

(22) PCT Filed: May 8, 2006
(86) PCT No.: PCT/IB2006/051432

§ 371 Date: Mar. 16, 2009

(30) Foreign Application Priority Data
May 9, 2005 (ZA) 2005/03705

(51) Int. Cl. B60R 22/20

(52) U.S. Cl. 280/801.2

(57) ABSTRACT

A restraining kit for restraining a person in a vehicle, includes a wearable harness which is wearable by a person and securing means for securing the wearable harness to a body of the vehicle when it is being worn by the person. The wearable harness includes shoulder straps, a waist strap and a crotch strap and the securing means is a second harness which is secured or securable to a seat of the vehicle. The restraining kit includes a buckle clip mechanism by which the wearable harness is securable to the second harness.

THIS INVENTION relates to passenger safety in vehicles. It relates, in particular to a restraining kit for restraining a person in a vehicle and to a method of restraining a person in a vehicle. The kit and method of the invention are particularly intended for the safety of children in vehicles but are not limited to this use.

According to a first aspect of the invention, there is provided a restraining kit for restraining a person in a vehicle, the kit including a wearable harness which is wearable by a person; and

securing means for securing the wearable harness to a body of the vehicle when it is being worn by the person.

The wearable harness will typically be of a size suitable to fit a child or toddler.

The wearable harness may include straps or belts for securing the wearable harness to the body of the person. It may, for example, include shoulder straps, a waist strap and a crotch strap. In an embodiment of the invention, the wearable harness may comprise a body portion from which the straps or belts extend. The body portion may be broadly rectangular in shape. The wearable harness will typically be fabricated, at least in part, from webbing material of the type used in the manufacture of motor vehicle seat belts. The wearable harness may be provided with additional securing means for securing one or more belts or straps to the harness. The securing means may be in the form of one or more rings or loops. In this embodiment, the wearable harness may conveniently be used outside of a vehicle to restrain a child or toddler by attaching a length of strap or belt to the ring dog leash-fashion, for example with a clip or buckle, when walking with the child or toddler. Instead, a pair of rings may be provided on the wearable harness for engagement with a harness on a mother for carrying the baby, papoose-fashion. In this embodiment, a mother can simultaneously carry a baby and keep a toddler in check while walking.

The wearable harness will also allow a mother to restrain a baby on her lap, or when breast-feeding, by passing the straps of a conventional motor vehicle safety belt through the straps of the wearable harness or by clipping or otherwise attaching the safety belt of the vehicle to the wearable harness.

The securing means for securing the wearable harness to the body of the vehicle may also be in the form of securing straps or belts which, in use, secure the wearable harness to a seat of the vehicle.

In a preferred embodiment of the invention, the securing means for securing the wearable harness to the body of the vehicle may be in the form of a second harness which is secured or securable to a seat of the vehicle.

The second harness may include straps which are securable to a rear of the seat of the vehicle.

The kit may include a buckle or clip mechanism by which the wearable harness is securable to the second harness.

For example, the second harness may include a pair of seat attachment straps which are arranged to extend around the rear of the seat of the vehicle to secure the second harness to the rear of the seat, shoulder straps which are arranged to extend over the shoulders of the person and a waist strap or belt which is arranged to extend around a waist of the person.

In a preferred embodiment of the invention, the wearable harness and the second harness may each include part of a buckle or clip mechanism so that the wearable harness and the second harness can be secured by a single buckle or clip.

In a development of the invention, the part of the buckle or clip mechanism which forms part of the wearable harness may include an attachment formation for attachment of a belt or lead for securing a child or toddler as described above.

The shoulder straps and waist strap may be adjustable to accommodate persons of different sizes. For example, the shoulder straps and waist straps may be secured to the seat attachment straps by means of slidable guides. The guides may be removable.

The second harness may, further, include anchoring means to prevent displacement of the seat attachment straps relative to the rear of the seat. The anchoring means may be in the form of an anchor belt for anchoring the attachment straps to the seat. The anchor belt will typically extend beneath the seat and, in use, be anchored to the seat itself or to the floor of the vehicle.

The restraining kit may include at least one reinforcing member for reinforcing the seat of the vehicle to limit deformation of the seat by the second harness. For example, the kit may include a moulded member of a rigid synthetic polymeric material or the like which fits at least partly over the rear of the seat to prevent deformation of the seat when force is exerted on the second harness for example when the vehicle is braking. The kit may instead, or in addition, include a second moulded member which is shaped to fit under the rear part of the vehicle seat.

An important feature of the combination of the wearable harness and the second harness is that a child or toddler can be restrained in a semi-prone or prone position with the seat reclined because the crotch strap prevents “submarining” or forward movement of the child or toddler if the vehicle is braked.

The second harness may conveniently be fitted to a vehicle and remain as a fixture of the vehicle.

In an embodiment of the invention, the restraining kit may, in addition, include a seat height adjustment assembly which comprises a cushioned body having at least two connected cushions which are arranged side-by-side and which are foldable relative to one another. The assembly may include locating means for locating the cushioned body on a vehicle seat. The assembly will typically include between two and four cushions connected together side-by-side so that they can be folded, to form a height adjustable cushioned support on which a child or toddler can sit, or unfolded into an extended configuration in which the assembly can function as a back support.

The locating means for locating the cushioned body on the vehicle seat may be selected from belts, straps, hook-and-eye connectors and buckles. Preferably, the cushioned body will comprise four cushions connected together. In a preferred embodiment of the invention, the locating means may be in the form of buckles or clips which are engageable with the seat attachment straps of the second harness.

The kit may, further, include seat covers to protect the seat of the vehicle. The seat covers may be provided with stiffeners. The seat covers may include a lower or squab cover and a seat rear cover.

According to a second aspect of the invention, there is provided a method of restraining a person in a vehicle, the method including the steps of fitting a wearable harness to the person and securing the wearable harness to a body of the vehicle.

The method may include securing the wearable harness to a seat of the vehicle with a second harness.

The method may include securing the wearable harness to the second harness by means of a buckle or clip mechanism in which part of the buckle or clip mechanism forms part of the wearable harness and part of the buckle or clip mechanism forms part of the second harness.

According to another aspect of the invention, there is provided a seat height adjustment assembly which comprises a cushioned body having at least two connected cushions which are arranged side-by-side and which are foldable relative to one another. The assembly may include locating means for locating the cushioned body on a vehicle seat. The assembly will typically include between two and four cushions connected together side-by-side so that they can be folded, to form a height adjustable cushioned support on which a child or toddler can sit, or unfolded into an extended configuration in which the assembly can function as a back support.

The locating means for locating the cushioned body on the vehicle seat may be selected from belts, straps, hook-and-eye connectors and buckles. Preferably, the cushioned body will comprise four cushions connected together. In a preferred embodiment of the invention, the locating means may be in the form of buckles or clips which are engageable with the seat attachment straps of the second harness.

The invention will now be described by way of example, with reference to the following diagrammatic drawings, in which:

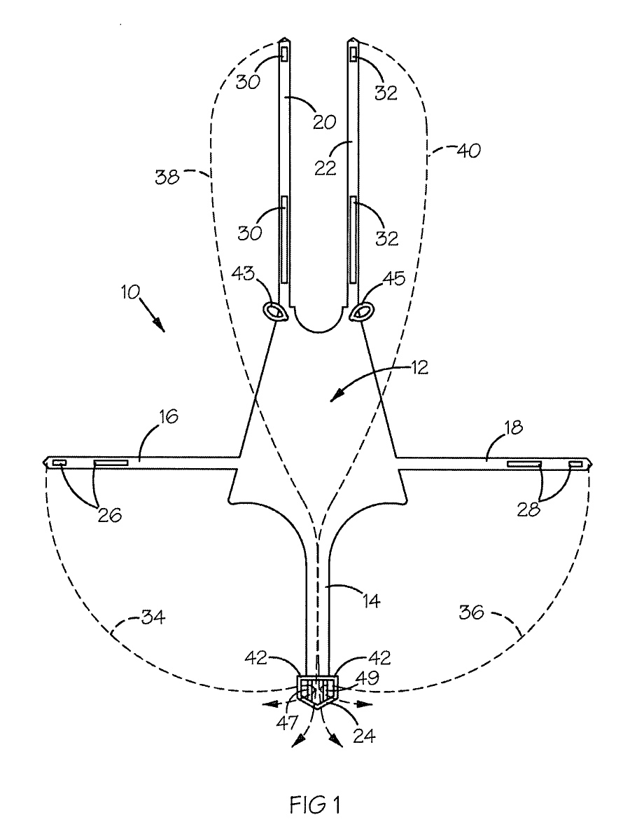

FIG. 1 shows a first embodiment of a wearable harness in accordance with the invention;

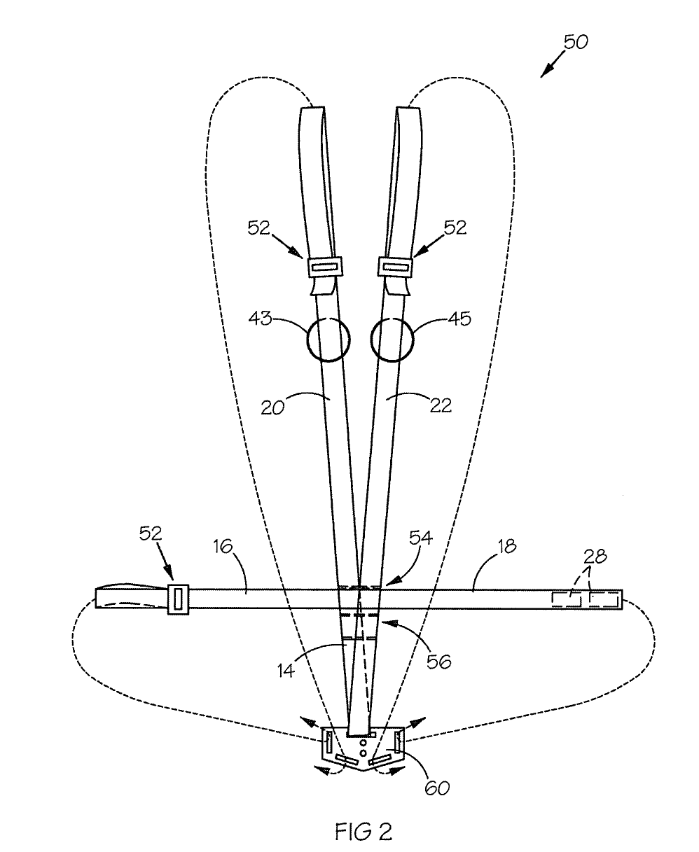

FIG. 2 shows a second embodiment of a wearable harness; FIG. 3 shows an embodiment of a second harness in accordance with the invention;

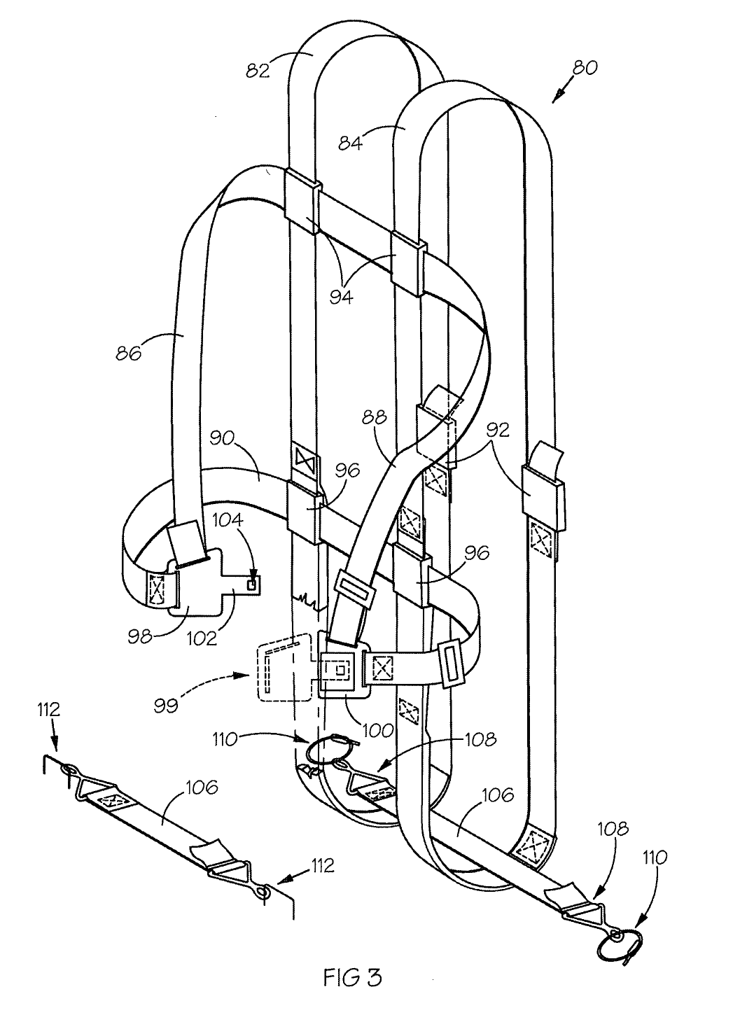

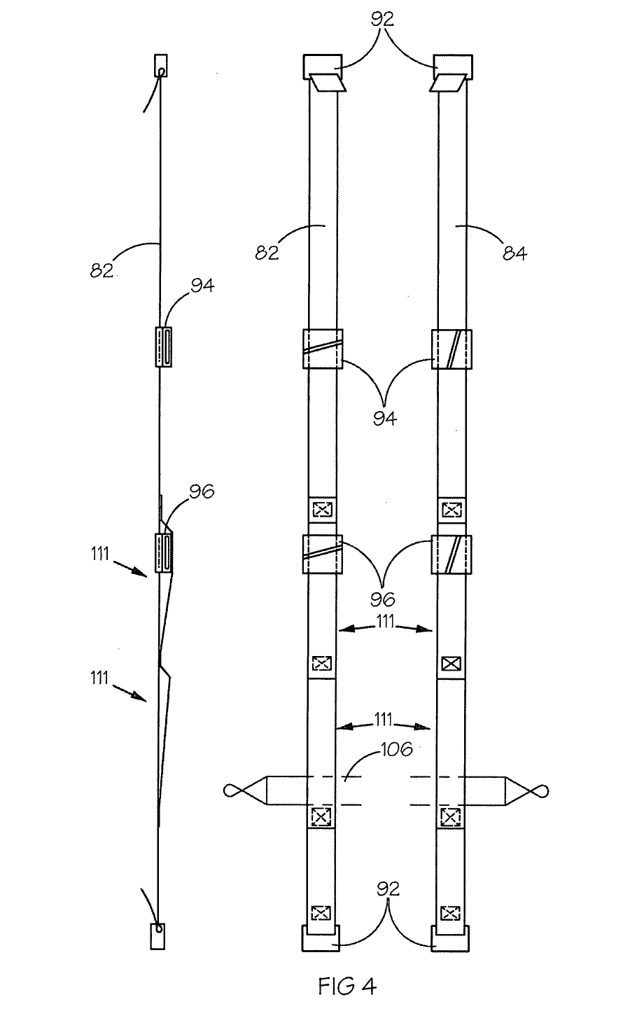

FIG. 4 shows parts of the harness of FIG. 3;

FIG. 5 shows a plan and side view of the releasable safety guides of the harness of FIG. 3;

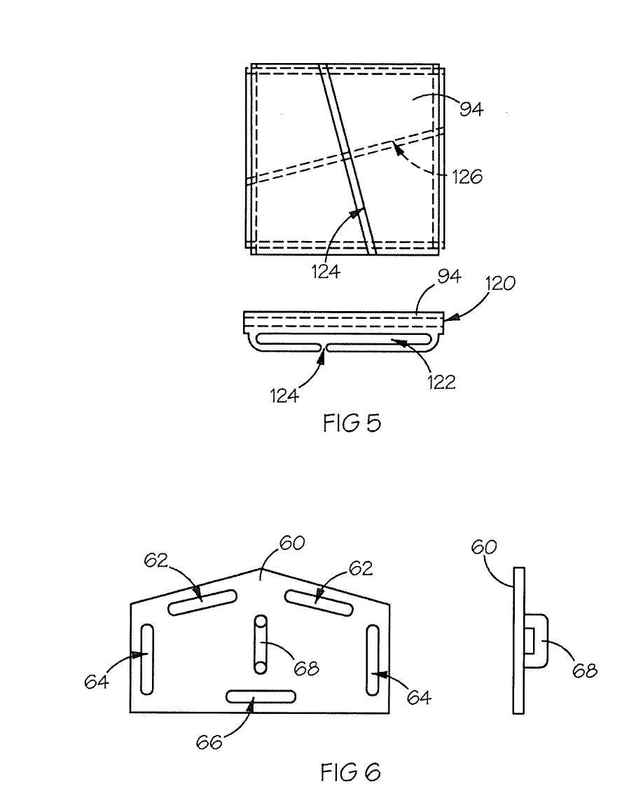

FIG. 6 shows a plan and a side view of the buckle of the wearable harness of FIG. 2;

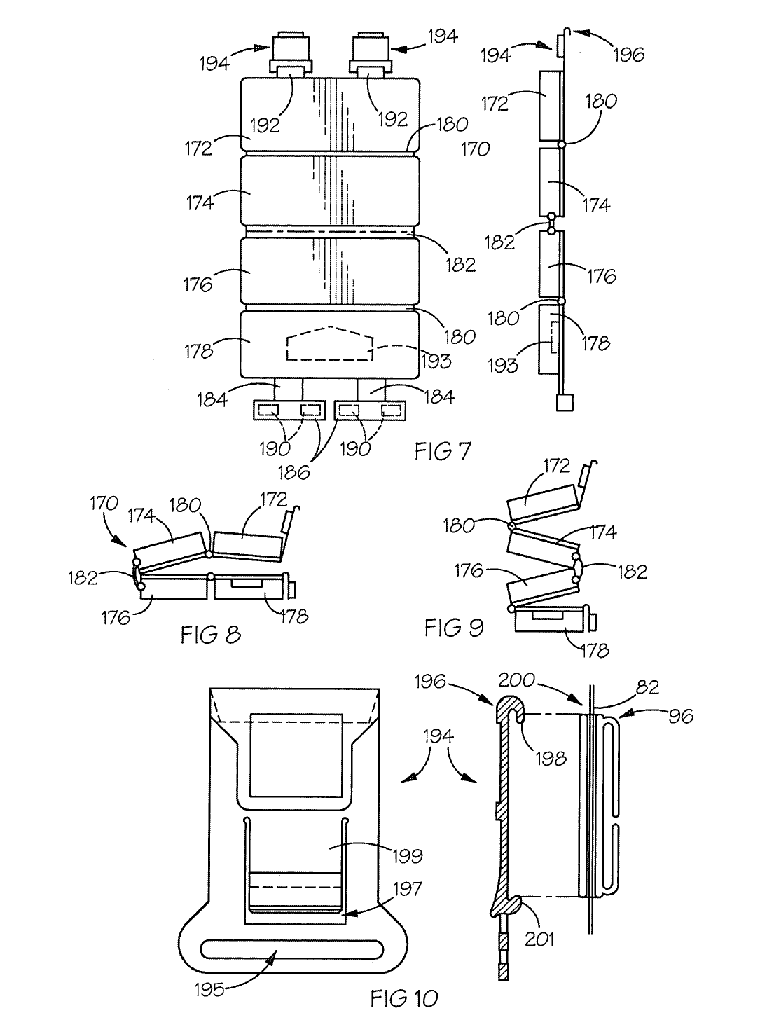

FIG. 7 shows front and side views of a seat height adjustment assembly;

FIGS. 8 and 9 show side views of the assembly of FIG. 7 in two folded configurations;

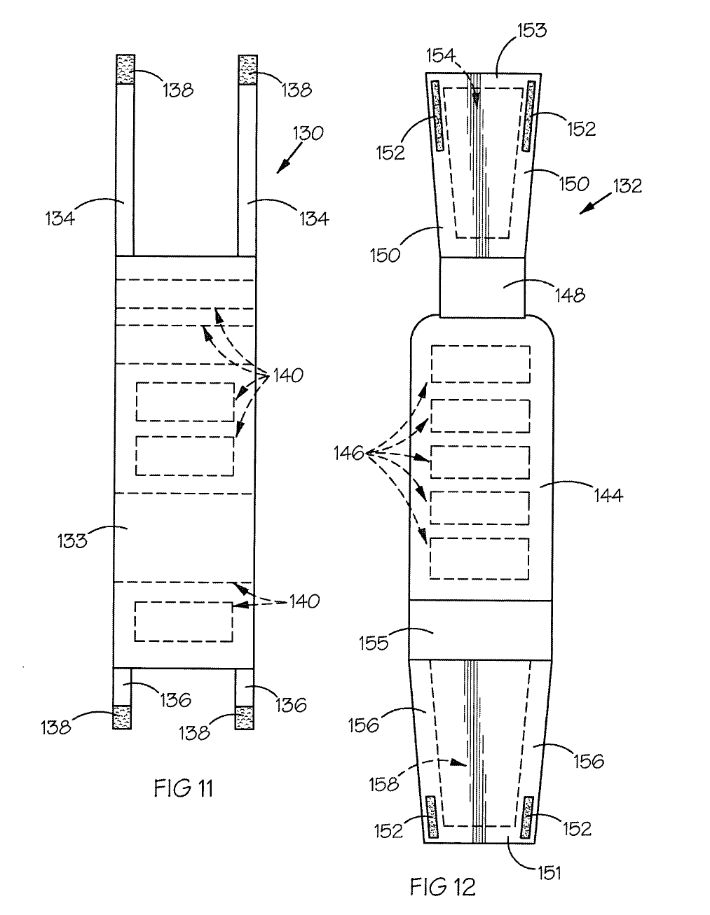

FIG. 10 shows front and side views of the clips of the assembles of FIGS. 7;

FIGS. 11 and 12 show embodiments of a seat cover and a seat back cover;

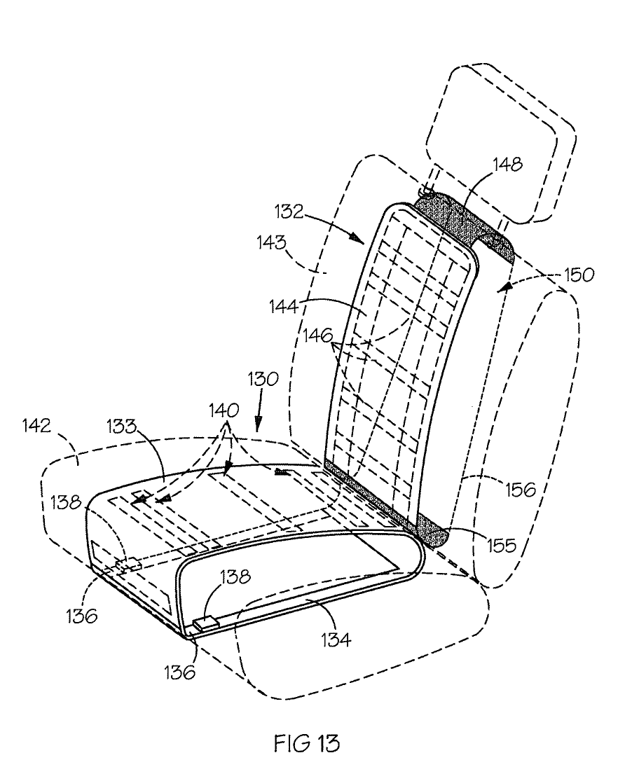

FIG. 13 shows another embodiment of a seat cover and a back cover attached to a vehicle seat;

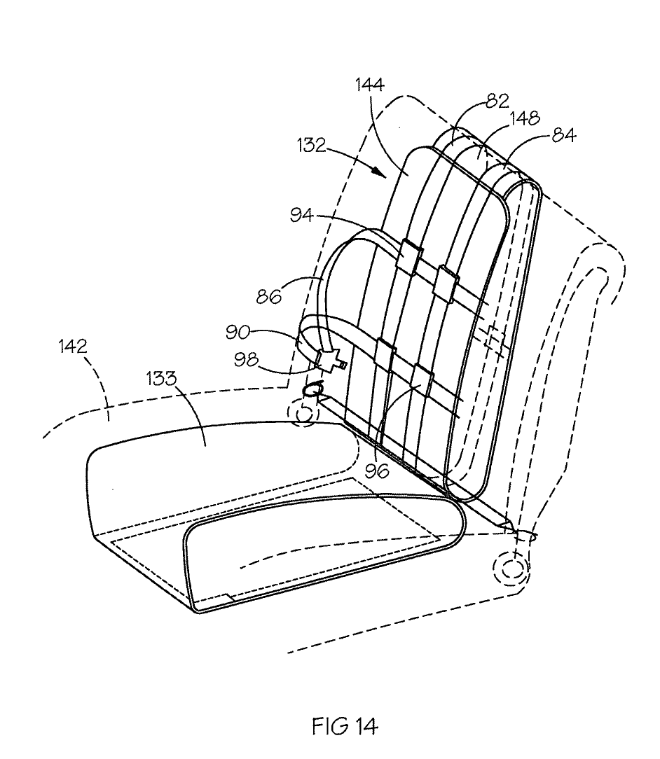

FIG. 14 shows the seat covers and seat of FIG. 13 and part of the second harness of FIG. 3;

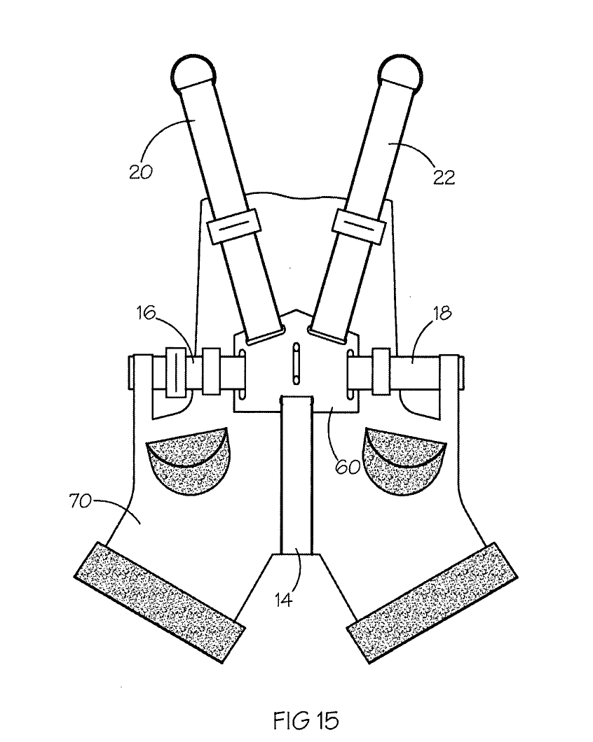

FIG. 15 shows another embodiment of a wearable harness;

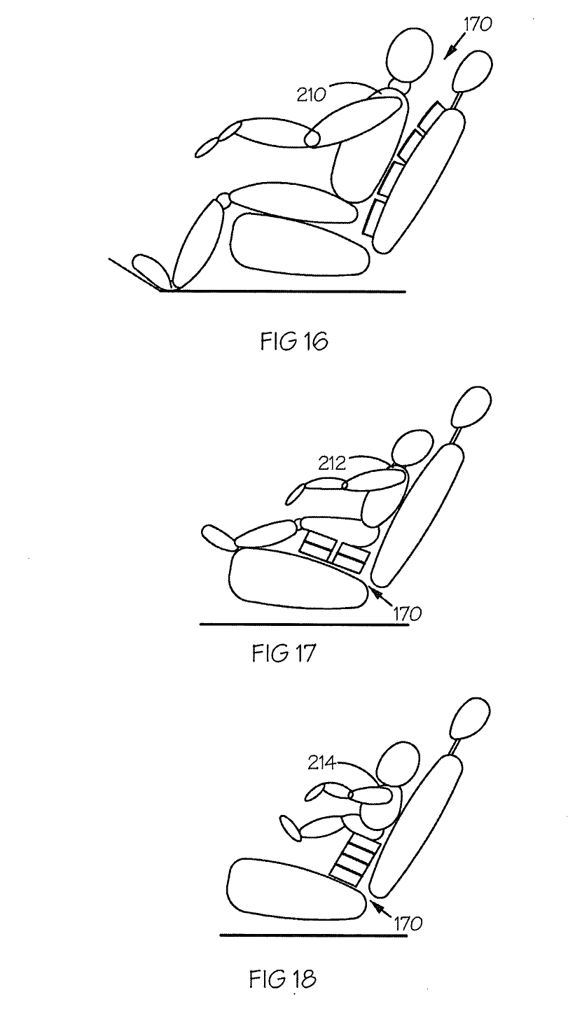

FIGS. 16 to 18 are schematic drawings of the height adjustment assembly of FIG. 7 in use; and

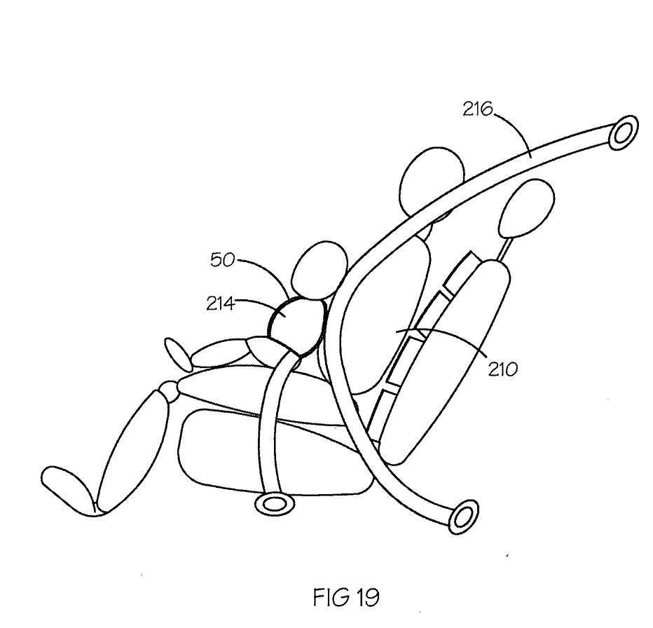

FIG. 19 is a schematic drawing of a baby wearing the wearable harness of FIG. 2 and an adult wearing a seat belt linked to the wearable harness.

In FIG. 1, reference numeral 10, generally indicates a wearable harness, in accordance with the invention. The harness 10 has a central body 12, which is shaped and dimensioned to be positioned behind the back of a person (not shown), a crotch strap 14, which extends operatively downwardly, in use to be passed between the legs of a wearer, from the back to the front, a set of waist straps 16, 18, extending laterally to fit around the waist of the person and a set of shoulder straps 20, 22, extending operatively upwardly from the body 12, to fit over the shoulders of the person.

The crotch strap 14 includes a fastener in the form of a buckle 24, comprising an outer member 42 and two cross-members 47, 49 and the waist straps 16, 18 and the shoulder straps 20, 22 include fasteners in the form of pairs of spaced apart complementary hook and eye connectors, such as Velcro™ strips, 26, 28 and 30, 32 respectively on the waist straps 16, 18 and the shoulder straps 20, 22.

In use, the waist straps 16, 18 are passed through the buckle 24 around the cross-members 47, 49 along the paths indicated by arrows 34, 36, and the shoulder straps 20, 22 are passed between the cross-members 47, 49 through the buckle 24 along the paths indicated by arrows 38, 40. The ends of the straps 16, 18, 20, 22 are then fastened with the Velcro™ strips 26, 28, 30, 32, by folding each strap back on itself.

Two rings 43, 45 are provided on the upper part of the body 12 adjacent the shoulder straps 20, 22. In use, the rings 43, 45 can be used to suspend a baby, papoose-fashion, from a halter or harness attached to a person, for example the mother of the baby.

Referring to FIG. 2, reference numeral 50 generally indicates a second embodiment of a wearable harness in accordance with the invention. The harness 50 resembles the harness 10 and the same reference numerals have been used to indicate the same or similar features of the harnesses 10 and 50. The this embodiment, the central body 12 is absent, the crotch strap 14 is formed by an extension of the shoulder straps 20, 22 and the waist straps 16, 18 are parts of a single length of strap and simply extend outwardly from the shoulder straps 20, 22.

Further, in this embodiment, slider adjusters 52 are provided on the shoulder straps 20, 22 and on the waist strap 16. The shoulder straps 20, 22 are provided with two openings 54, 56 formed by double layers of the webbing material from which the straps 20, 22 are fabricated. The single strap or belt comprising the waist straps 16, 18 extends through the opening 54. The waist straps 16, 18 can, instead, be moved to extend through the opening 56 so that the position of the waist straps 16, 18 is adjustable.

In this embodiment, the buckle 24 is replaced by a plate 60 which is provided with slots 62 for securing the shoulder straps 20, 22, slots 64 for receiving the waist straps 16, 18 and a slot 66 for receiving the crotch strap 14. In addition, the plate 60 is provided with a metal loop 68 as described in further detail below. The metal loop 68 will preferably be large enough to receive a strap or belt such as a dog leash or a length of webbing. The loop 68 can be used to secure a baby to a seat belt while sitting on its mother's lap.

In a variation of this embodiment of the invention, as shown in FIG. 15, the wearable harness 50 embodies a pair of shorts 70 of a material such as denim™ so that the harness feels more like normal clothing to a toddler. In similar embodiments, the harness of the invention can be in the form of other items of clothing such as dresses or the like.

Referring now to FIG. 3, reference numeral 80 generally indicates an embodiment of a second harness in accordance with the invention. The second harness 80 has seat attachment straps 82, 84, shoulder straps 86, 88 and a waist belt 90. The straps 82, 84 are arranged to pass around the rear of a vehicle seat, as shown in FIG. 14, and each consists of a single length of webbing material secured by a clip 92. The shoulder straps 86, 88 also each consist of a single length of webbing material which extends through releasable safety guides 94 which are slidably connected to the shoulder straps 82, 84. The waist belt 90 similarly extends through releasable safety guides 96 which are also slidably connected to the shoulder straps 82, 84 below the guides 94 as can be seen in the drawing. The end of the strap 86, and one end of the waist belt 90 are connected to a first part 98 of a two-part buckle 99 (shown partly in dotted lines in the drawing) and the end of the strap 88 and the other end of the waist belt 90 are connected to the second part 100 of the two part buckle 99. The part 98 has a tongue 102 with an opening 104 and is receivable in the part 100 as shown in dotted lines in the drawing, in the manner of a car or airline seat belt, to lock the ends of the belt 90 together in conventional fashion. However, the two-part buckle 99 has the additional feature that the tongue 102 projects through the loop 68 of the buckle 24 so that the two-part buckle 99 formed from the two parts 98, 100 also links the plate 60 to the two-part buckle 99, thereby securing the wearable harness 50 to the second harness 80.

An anchor strap 106 extends between, and is attached to, the seat attachment straps 82, 84 as shown in the drawing and is provided with standard buckles 108 with adjustable links for tightening the strap 106. The strap 106 is anchorable to the frame of the seat (shown schematically at 112) to prevent movement of the straps 82, 84. Looped lengths of cable 110 are provided for engagement with the bottom hinge member of seats on older cars.

FIG. 4 shows front and side views of the webbing seat attachment straps 82, 84. As can be seen in the drawing, the webbing has a double layer, indicated by the arrows 111, where the releasable safety guide 96 is positioned and in the region of the anchor strap 106 to further secure the harness 80 and prevent injury during capsizing of the vehicle.

FIG. 5 shows one of the releasable safety guides 94. The guide 94 is in the form of a flat body which defines a first flattened channel 120 (shown in dotted lines) and a second flattened channel 122 which is arranged at right angles to the first channel 120. The seat attachment straps 82, 84 extend through the channels 122 of the guides 94, 96 as can be seen in FIG. 4. The shoulder straps 86, 88 and the waist belt 90 then extend through the second channels 120, as can be seen in particular in FIG. 3. The guides 94 are slidable up and down along the seat attachment straps 82, 84. The shoulder straps and waist straps 86, 88 and 90 respectively are inserted into the second channels 120 through diagonally arranged slots 124 in the guides 94, 96 and the seat attachment straps 82, 84 are inserted into the first channels 120 through corresponding slots 126 in the guides 94, 96.

Referring now to FIGS. 11 and 12, reference numerals 130 and 132 respectively indicate a seat cover and a back rest or seat back cover in accordance with the invention. The seat cover 130 is of conventional construction and comprises an elongate rectangular cover member 133 having an upper end from which two longer strips of webbing 134, with a cross-strap 153 extending between their ends, project and a lower end from which two shorter strips of webbing 136 with a cross-strap 151 extending between their ends, project. The strips 134, 136 are provided with complementary lengths of hook-and-eye connectors, such as Velcro™, for securing the strips 134, 136 together. The cover body 132 is provided with internal stiffening members, for example, of a synthetic polymeric or plastics material, as shown by the dotted lines 140. In use, as shown in FIG. 13, the seat cover 130 extends over the seat 142 of the vehicle and is secured by the straps 134, 136 and the Velcro™ connectors 138. In the embodiment shown in FIG. 13 the stiffening members are differently arranged from those of FIG. 11 as can be seen in the drawing.

Referring, now, to FIG. 12, the back rest cover 132 comprises an elongate generally rectangular shaped cover member 144 which is also provided with internal stiffening members 146, shown in dotted lines, similar to the stiffening members 140 of the seat cover 130. The cover member 144 is attached to a rigid moulded formation 148 of a synthetic polymeric material at its upper end which is shaped to fit over the upper part of the back 143 of the seat 142 (as shown in FIG. 13) and two strips 150, similar to the strips 134 of the seat cover 130 extend from the moulded formation 148. Velcro™ strips 152 are provided at the end of the strips 150. A netting 154 is provided between the strips 150.

A second moulded formation 155 is provided at the bottom of the cover member 144 and is shaped to fit around the bottom of the seat back or back rest 143, as shown in FIG. 13. Two webbing strips 156 with complimentary Velcro™ strips 152 at their ends extend from the moulded formation 155. A netting 158 extends between the strips 156 in similar fashion to the netting 154.

In use, as shown in FIG. 13, the back rest cover 132 is secured to the back rest 143 by securing the Velcro™ strips 152 of the webbing strips 150 and 156, as shown schematically by the dotted line, so that the moulded formations 148, 155 are located at the top and the bottom of the back rest 143 as can be seen in the drawing. In this embodiment, the stiffening members 146 are again arranged differently from those of FIG. 12, as can also be seen in the drawing.

Referring now to FIG. 7, reference numeral 170 generally indicates a seat height adjustment assembly in accordance with the invention. The assembly 170 consists of four cushions 172, 174, 176, 178 which are connected together with strips of webbing material. The top and bottom cushions 172, 178 are respectively connected to the two central cushions 174, 176 at their bases by strips of webbing material 180 whilst the central cushions 174, 176 are centrally connected by a strip of webbing 182. In this way, the assembly 170 can be folded in different ways as depicted in FIGS. 8 and 9.

The assembly 170 further includes two webbing straps 184 projecting from the lower cushion 178 with cross strips 186 at their ends, each provided with complementary Velcro™ strips 190 so that the cross strips 186 can be wrapped around and secured to the seat attachment straps 82, 84. Two further webbing straps 192 project upwardly from the top cushion 172 and each is provided with a dip 194 as shown in further detail in FIG. 10. The cushion 178 further includes a storage recess or pouch 193 for storing the buckle parts 98, 100 of the two part buckle 99 when the harness 80 is not in use.

The clips 194 are of a synthetic polymeric material and have elongate openings 195 which are engaged with the straps 192 in conventional fashion. The clips 194 are provided with U-shaped slits 197 which define flaps 199.

As can be seen in the side view of FIG. 10, the clips 194 are provided with a hook-shaped formations 196 which, in use, engage with one of the releasable safety guides 96. The end 198 of the hook formation 196 is tapered, as can be seen in the side view in FIG. 10, and, in use engages with a gap 200 between the strap 82 and the body of the guide 96 where it is held by a friction fit. This prevents the guide 96 from sliding downwardly under the weight of the assembly 170. The lower end of the guide 96 has a shoulder 201 which, in use, abuts the bottom edge of the guide 96. In order to disengage the clip 194 from the guide 96 the flap 199 is lifted.

In FIGS. 16 to 18, the height adjustment assembly 170 is shown in use.

In FIG. 16, the assembly 170 is shown in its extended configuration with the cushioned compartments 172, 174, 176, 178 lying next to each other behind the back of an adult 210.

In FIG. 17, the assembly 170 is folded in half along the strip 182 and is used to adjust the seating position of a child 212.

In FIG. 18, the assembly 170 has been folded along the strips 180, 182 so that all four of the cushions 172, 174, 176, 178 are positioned one above the other thereby to adjust the seating position of a toddler 214.

In FIG. 19, the harness 50 is worn by a toddler 214 and the toddler 214 is sitting on the lap of an adult 210. The adult 210 is wearing a conventional seatbelt 216, which is threaded through slits (not shown) in the harness 50 or behind the straps 20, 22 of the harness 50 to retain the toddler 214 in position on the lap of the adult 210.

In use a child or toddler, for example, is fitted with the wearable harness such as the harness 50 depicted in FIG. 2 with the shoulder straps 20, 22, the waist straps 16, 18 and the crotch strap 14 all connected to the buckle 24. The child is then secured to the seat of a vehicle with the second harness 80 with the metal loop 68 of the plate 60 engaged with the two-part buckle 99 formed by the first and second parts 98, 100 of the two part buckle 99. In this way the child or toddler can readily be removed from the vehicle by unclipping the buckle 99 with the wearable harness 50 still being worn.

The invention as illustrated provides a new method of retaining a person in a vehicle, by attaching the wearable harness 10, 50 to a person and by securing the wearable harness 10, 50 to a seat of a vehicle by means of the second harness 80. The second harness 80 has several advantages when compared with similar child-restraining harnesses. Existing harnesses do not have the dual purpose buckle of the invention or the adjustable features which allow the kit to be used for children or toddlers of different sizes. Prior art harnesses also do not include the cushioned seat height adjustment assembly of the invention, parallel belts around the back rest or the anchor belt of the kit of the invention. The wearable harness of the kit of the invention also allows external use as a child-restraining harness and allows use in combination with conventional vehicle seat belts.

The inventor believes that the invention provides a more convenient but safe method of securing a person, in particular a child or toddler in a vehicle. Because of its convenience and versatility, the inventor has found that the kit as illustrated is more likely to be used than conventional child-restraining arrangements and will therefore improve the safety of passengers, in particular young children and toddlers, in a vehicle.

The invention is multi-functional and flexible to use and does not require removal from the vehicle when an adult needs to use the same seat. The design has been formulated around a child's specific needs as it grows and requirements change.

1. A restraining kit for restraining a person in a vehicle, the kit including
a wearable harness which is wearable by a person; and
securing means for securing the wearable harness to a body of the vehicle when it is being worn by the person, the wearable harness including shoulder straps, a waist strap and a crotch strap, the securing means comprising a second harness which is secured or securable to a seat of the vehicle, the kit including a buckle or clip mechanism by which the wearable harness is securable to the second harness, the wearable harness and the second harness each including part of the buckle or clip mechanism so that the wearable harness and the second harness can be secured by a single buckle or clip, the second harness including a pair of attachment straps which are arranged to extend around the rear of the seat of the vehicle to secure the second harness to the rear of the seat, shoulder straps which are arranged to extend over the shoulders of the person and a waist strap which is arranged to extend around a waist of the person, the shoulder straps and waist strap being adjustable to accommodate persons of different sizes and the second harness including anchoring means to prevent displacement of the attachment straps relative to the rear of the seat.

2. A restraining kit as claimed in claim 1, in which the anchoring means is in the form of an anchor belt for anchoring the attachment straps to the seat.

3. A restraining kit as claimed in claim 1, which includes at least one reinforcing member for reinforcing the seat of the vehicle to limit deformation of the seat by the second harness.

4. A restraining kit as claimed in claim 1, which includes a seat height adjustment assembly which comprises a cushioned body having at least two connected cushioned compartments which are arranged side-by-side and which are foldable relative to one another and locating means for locating the cushioned body on a vehicle seat.

5. A restraining kit as claimed in claim 4, in which the locating means for locating the cushioned body on the vehicle seat is selected from belts, straps, hook and eye connectors and buckles.

6. A restraining kit as claimed in claim 5, in which the locating means is engageable with the attachment straps.

7. A restraining kit as claimed in claims 4 which the cushioned body comprises four cushioned compartments.

8. A seat height adjustment assembly for use on a vehicle seat, the assembly comprising a cushioned body having at least three connected cushions which are arranged side-by-side and which are connected together so that they are foldable relative to one another in a zig-zag or concertina fashion to be located one above the other to provide a stack of cushions and locating means for locating the cushioned body on a vehicle seat.

9. A seat height adjustment assembly as claimed in claim 8, in which the locating means for locating the cushioned body on the vehicle seat is selected from belts, straps, hook and eye connectors and buckles.
